(19) United States
(12) Patent Application Publication
(10) Pub. No.: US 2002/0059128 A1
(43) Pub. Date: May 16, 2002

(54) Method and computer system for controlling communications between contracting parties

(76) Inventor: Peter Pesch, Vienna (AT)

Correspondence Address: Law Offices of Karl Hormann, 86 Sparks Street, Cambridge, MA, 02138-2216, US

(21) Appl. No.: 09/742,155

(22) Filed: Dec. 20, 2000

(30) Foreign Application Priority Data
Nov. 14, 2000 (EP) 00890339.5

(51) Int. Cl. G06F 17/60

(52) U.S. Cl. 705/37

(57) ABSTRACT

A method and a computer system for the implementation thereof, for controlling communications between first and potential second contracting parties about third party subject matter furnished by an agent on the basis of bids placed by the second contracting parties for the third party subject matter. Acceptance of the bid, or closing of a contract, is determined by such criteria as the amount of bid and closing fees, classification of contractual subject matter and/or second contracting parties. The system provides for transfer of at least a share of the bid and closing fees to the agent when a contract is consummated, and for return transfer to the second contracting party in the absence of a consummated contract.

### BACKGROUND OF THE INVENTION.

1. Field of the Invention

The invention, in general, relates to a novel method and a computer system for controlling communications between a first contracting party and potential second contracting parties, as well as to a computer program embodied on a machine readable data carrier for implementing the method and system.

2. The Prior Art

Many systems exist for controlling communications between potential contracting parties such as, for instance, solicitation media, advertising media, electronic bulletin boards, etc. However, no systems have become known to date which automatically provide or initiate business contacts for closing contracts or bargains.

### OBJECT OF THE INVENTION.

Therefore, it is an object of the invention to provide a system of the kind referred to, the transaction costs of which are lower per communication contact with potential contracting parties than those of conventional solicitation and information media.

### BRIEF SUMMARY OF THE INVENTION.

In a first aspect, the object is accomplished by a method of controlling the communication between at least one first contracting party and one or more potential second contracting parties on the basis of third party information from an agent, the third party information including at least the identity of the first contracting party and a description of the subject matter of the contract, the method including the steps of:

a) receiving and storing the third party information;

b) providing access to the contractual subject matter of the third party information for queries by second contracting parties;

c) receiving bids from second contracting parties for access to the identity of the first contracting party, each bid including at least a statement of a closing fee offered by the second contracting party for closing a contract with the first contracting party; receiving a bid fee for each bid from each second contracting party making a bid; and storing the bids and bid fees, and

d) determining the bids with the N highest statements of closing fees at a predetermined time with N≧1; transmitting the identity of the first contracting party to the N second contracting parties making the N bids; and transmitting at least a portion of all bid fees to the agent.

The invention is based upon utilizing information received from third parties not otherwise involved in the actual transaction, which information is of potential relevance to concluding a contract, for automatically controlling the communication and, hence, stimulation of further communicative action between potential contracting parties. The third party information is separated into a so-called “private” component including the identity of the first contracting party necessary for direct communication between the first contracting party and a second contracting party and a so-called “public” component which in the manner of a “teaser” is to rouse the interest of potential second contracting parties in having the private component of the third party information disclosed.

In accordance with the invention an auction for the disclosure of the private component of the third party information is conducted among the interested potential second contracting parties. The complete third party information will be disclosed to the possibly more than one winners (N=2, 3 . . .) of the auction. However, the parameter of the auction on which bids are placed is not the price of the third party information per se, but, rather, a closing fee which is levied only if a contract is actually closed.

Hence, the auction centers about a “fictitious” value and the merit of the invention resides in the recognition that the auction may nevertheless be conducted effectively. If in praxi the bid fee is set low, it is likely to result in high user acceptance.

The separation in accordance with the invention between a bid fee for participation in the auction and a closing fee as an auction-decisive parameter ensures a life-like and realistic auction to which admission may be gained by overcoming a low threshold. On the other hand, levying a bid fee and distributing it to the third party or agent providing the third party information will provided an excellent incentive to ensure that third party information will be provided to the system.

In a useful embodiment of the invention the actual state of the auction, and more particularly the N highest offered closing fees, may on demand be made available to all potential second contracting parties to give them an opportunity to make further bids up to a certain point in time. The costs of providing the business contact with the first contracting party are, therefore, at the discretion of every second contracting party and may accordingly be chosen to be lower than the costs required for conventional business contacts.

A particularly preferred embodiment of the invention is characterized by the additional steps of:

e) receiving evaluation data relative to the third party information within a predetermined interval of time, and

f1) if an evaluation data indicates that a contract has been closed between the first contracting party and one of the second contracting parties, receiving the closing fee included in the bid of the particular second contracting party and transmitting at least a share thereof to the agent, or

f2) if no evaluation data indicates closing of a contract, but evaluation data is received from a majority of the second contracting parties which have made the N bids, recovering the bid fees from the agent and returning them to the second contracting parties.

In this manner, user acceptance of the system may be increased even further. Evaluation data may be fed in by anyone, for instance by the agent, the second contracting party closing the contract, by the other N−1 potential second contracting parties which had won at the auction but had not closed a contract, or even by the first contracting party itself. If any one of these evaluation data indicates that a contract has been closed, it indicates the authenticity or genuineness of the third party information, and the closing fee offered at the auction will be collected.

For practical purposes, a major portion of the collected closing fees will be transmitted to the agent in order to entice it to provide further third party information.

On the other hand, the process of evaluating the evaluation data in accordance with the invention prevents any fraudulent input of obviously false third party information. For in that case, evaluation data will likely be received from at least some of the N potential second contracting parties which had received such non-genuine third party information. Such evaluation data will be classified as “complaints” and will cause the entire flow of bid fees to be reversed.

In a preferred embodiment, the method in accordance with the invention may be further refined by admitting only the bids carrying the M highest bid fee statements for determining the mentioned N bids, whereby M>N. This makes for an additional threshold for admission to the auction, i.e. the auction process becomes, in fact, a dual-stage one.

In a preferred embodiment it is possible also for the purpose of determining the mentioned N bids to accept only those bids the bid fee of which exceeds a predetermined threshold value. In this manner, a uniform entry threshold is established or demanded for the auction, which is of particular advantage in those variants of the process in which the bid fee for each bidding second contracting party is either different or is set by the party itself.

Preferably, statistical data regarding third party information and/or evaluation data relating to all third party information will be maintained and updated with respect to every agent. In this manner, agents whose evaluation data is unfavorable may be excluded from providing further information, or access may be made particularly easy for agents whose data is favorable. In a preferred variation of the method in accordance with the invention, the mentioned share of bid fees and/or closing fees will be determined based on such statistical data. Agents furnishing a lot of third party information which in turns leads to many contracts being closed, and in respect of which little “complaining” evaluation data is received, may thus be accorded preferable treatment.

It is also of particular advantage if statistical data relative to bids and/or evaluation data is maintained and updated about every second contracting party making a bid to grant preferential treatment to contracting parties whose statistical data is favorable. In this connection, it is also of particular advantage if in accordance with the invention the bid fee determined on the basis of such statistical data is made available together with a description of the contractual subject matter and is received when a bid is made by such second contracting party. The bid fee charged for certain third party information may thus be individually determined in respect of given bidders.

Basically, there are different ways of determining the bid fee. On the one hand, the approach described above may be taken, especially in respect of individual second contracting party. In this connection, the bid fee may be determined based on a classification of the second contracting party. The bid fees may thus be differentiated between fields of business of individual second contracting parties or on the intended application (e.g. commercial or personal use).

Preferably, as an alternative in step c), a statement of the amount of the bid fee is received from the second contracting party. Thus, it is the second contracting parties which themselves determine the bid fee they wish to pay, as would be of particular advantage in dual-stage auction processes.

A particularly preferred variant of the method in accordance with the invention is characterized by the mentioned number N being made available for queries together with a description of the subject matter of the contract. This would put potential second contracting parties in a better position of estimating the worth of third party information and of deciding whether or not they wish to attend an auction, as the worth of the third party information is the higher the fewer the number of other potential second contracting parties Bᵢ to whom it is disclosed.

For that reason it is particularly advantageous if the third party information contains data about the quality of the information, preferably its origin, which is made available for querying together with a description of the contractual subject matter. Such data about the quality of the information, especially its origin, may, for instance, consist of a statement whether

a) the agent itself is the first contracting party (=highest quality of the third party information; in this case it is actually a first hand information or “first party information”; however, in this context the term “third party information” is intended to include this type of information);

b) the agent is in a position to influence the decision of the first contracting party regarding closing a contract;

c) the agent is merely privy to the decision of the first contracting party regarding the closing of the contract;

d) the agent has learnt from the first contracting party itself of its wish to close a contract; or

e) from a third party (hear-say) (=lowest quality level of the information).

In any case, it is particularly advantageous if in accordance with a further element of the invention the description of the contractual subject matter, when it is being recorded, is classified according to predetermined classes of contractual subject matter, preferably by means of an expert system guiding the agent. Alternatively, such classification may carried out during the query.

In this connection, the bid fee may be determined on the basis of the mentioned class of the contractual subject matter, that is to say, as an alternative or in addition to the possibilities of determining the bid fee in the manner described heretofore. Accordingly, the bid fee may be categorized on the basis of businesses or values. Thus, the bid fee levied for access to the identity of a contracting party in need of a high price construction vehicle will be higher than the fee in respect of short-lived consumer goods.

A further advantageous embodiment of the method in accordance with the invention is that access by a second contracting party to the description of the contractual subject matter is only granted depending on the classification of such second contracting party. Alternatively or additionally, the acceptance of bids from a certain second contracting party may be made subject to a classification of such second contracting party. Either measure makes it possible to block undesired bids.

A further aspect of the invention resides in the provision of a computer system for controlling the communication between at least one first contracting party and potential second contracting parties on the basis of third party information from an agent, the third party information including at least the identity of the first contracting party and a description of the contractual subject matter, comprising:

a first data base provided with an input interface for the agent by which third party information is received, the first data base being provided with a private section and a public section, at least the identity of the first contracting party being stored in the private section and the description of the contractual subject matter being stored in the public section, and further with a queries interface by which potential second contracting parties may query the public section;

an accounts maintenance device for keeping credit accounts for each agent inputting third party information;

a second data base including an input interface by which second contracting parties may input bids in order to be granted access to the private section of the first data base regarding specific third party information, each bid including at least a statement of a closing fee offered by that second contracting party to close a contract with the first contracting party, and each bid having associated therewith a predetermined bid fee;

an accounts maintenance device for keeping credit accounts for every second contracting party submitting a bid;

a collective storage for collecting bid fees, each submission of a bid into the second data base causing the transfer of the associated bid fee from the credit account of the submitting second contracting party to the collective storage; and

an auction device for determining from the second data base at a predetermined point in time the bids having the N highest statements of closing fees, wherein N≧1, for granting to every second contracting party which has submitted one of the N bids access to the private section of the first data base in respect of the third party information relevant to the bid, and for causing the transfer of a predetermined share of all bid fees collected in the collective storage to the credit account of the agent having furnished the relevant third party information.

The facility in accordance with the invention makes it possible to execute the described method automatically. As regards the manner of operation and the advantages of the facility, attention is thus directed to the relevant description of the method. Efficaciously, the facility in accordance with the invention is computer supported.

A particularly preferred embodiment of the computer system in accordance with the invention is characterized by the provision of an evaluation device with at least one input interface for receiving evaluation data which evaluation device enables reception of evaluation data relating to the third party information within a predetermined period of time and, subject to an indication by the evaluation data that a contract has been closed between the first contracting party and one of the second contracting parties, causes the transfer of at least a share of the closing fee stated in the bid of that second contracting party from its credit account to the credit account of the agent or, if none of the evaluation data indicates that a contract has been closed but evaluation data exists from a majority of the second contracting parties who did submit the N bids, causes the reverse transfer of the bid fees from the credit account of the agent to the credit account of those second contracting parties. In this manner, security and user acceptance of the computer system is improved still further, as has been set forth supra.

Further characteristics and advantages of the computer system in accordance with the invention will in part be obvious and will in part appear hereinafter.

Finally, the invention also provides a computer program product embodied on a computer or machine readable data carrier which implements a method of the type disclosed.

The computer system in accordance with the invention may be realized by way of hardware as well as by software. Therefore, the invention also provides a computer program product stored on a computer readable data storage which represents a software implementation of the computer system disclosed.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 depicts a block circuit diagram of the computer system in accordance with the invention;

FIG. 2 schematically depicts the structure of a third party information data record in the first data base;

FIG. 3 schematically depicts the structure of a bid data record in the second data base; and

FIG. 4 shows the interaction and sequence diagram of the method according to the invention.

### DETAILED DESCRIPTION OF THE PREFERRED EMBODIMENTS

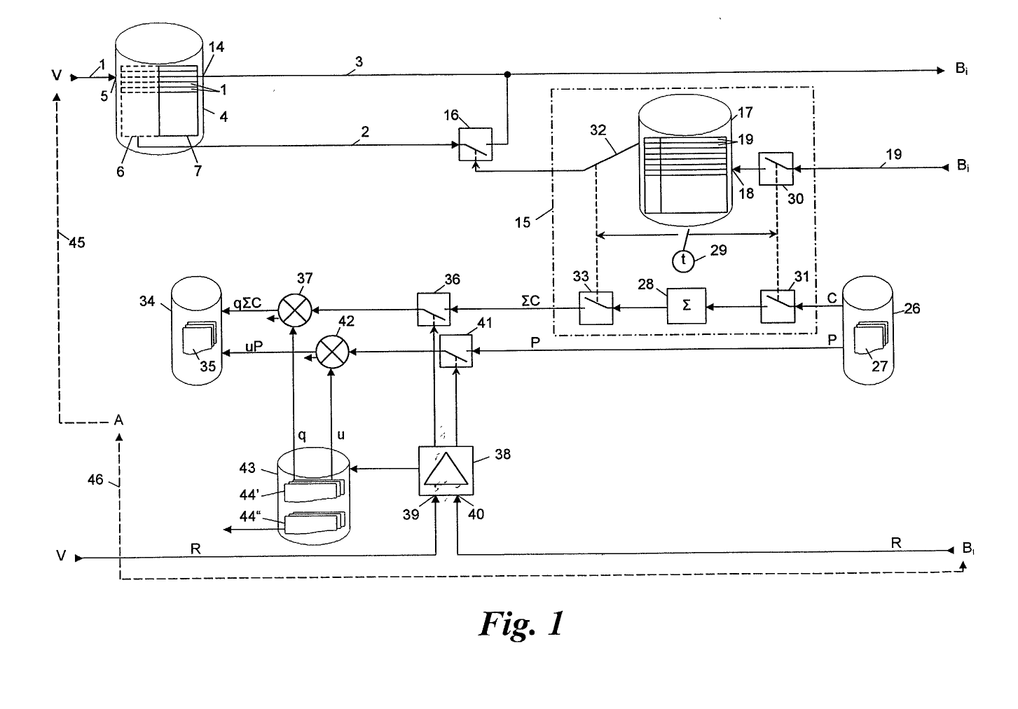

FIG. 1 shows a computer system for controlling communication between a first contracting party A and several potential second contracting parties B₁, B₂, . . . Bₙ, only one of these, Bᵢ, being shown in the drawing as representative of all of them. While, as indicated by broken line 46, direct communication between the first contracting party A and a second contracting party Bᵢ is carried on outside of the computer system of FIG. 1, it is nevertheless stimulated and controlled by the computer system of FIG. 1 on the basis of third party information 1 inputted into the computer system by an agent V.

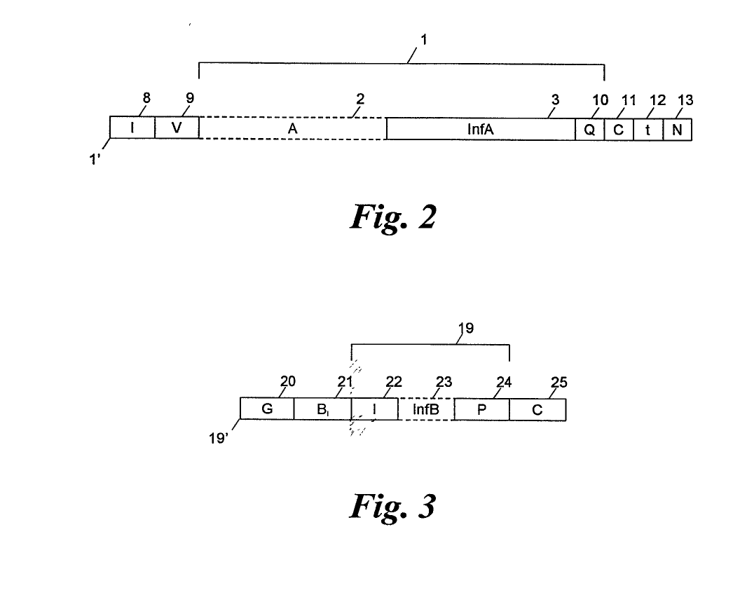

The third party information 1 includes at least a statement 2 about the identity of the contracting party A and a description 3 of the contractual subject matter on which contracting party A seeks to close a contract (see FIG. 2). As represented by broken line 45, the third party information 1 is passed on to the agent V either directly or by way of agents or media. In the simplest case (not shown), contracting parties A and the agent V are one and the same person.

The contractual subject matter may be of any kind. It may, for instance, be a purchase agreement, a sales agreement, an operating agreement, an employment contract, a rental agreement, etc. For instance, A may wish to purchase or sell an automobile, rent or let an apartment, conclude or offer an employment agreement, etc.

In accordance with FIG. 1, the computer system is provided with a first data base 4 for receiving third party information 1. The first data base 4 is provided with an input interface 5 for an agent V. The input interface 5 may be structured in any manner known in technology. For instance, it may be a computer terminal, or a server/client based internet system by which the agent V may access the data base 4 through a conventional internet browser; a voice response unit (VRU) for access over a public telephone network, or the like.

The first data base 4 is separated into a private section 6 and a public section 7. At least the identity of the contracting party 2 is stored in the private section 6, and at least a description of the contractual subject matter 3 is stored in the public section 7. In an actual case, however, data in addition to the third party information 1 is stored in the data base 4, such as, for instance, an unambiguous, unique information identification “I” 8 and an agent identification “V” 9 (see FIG. 2). Moreover, the agent V (or the operator of the computer system, if so desired) may additionally input a statement 10 as to the quality of the information stored in the public section 7. The information quality statement 10 may be presented in quality stages, such as, for instance, quality stages a) through e) referred to supra. The description of the contractual subject matter 3 may also contain quantitative statement about the desired contract, such as, for instance, maximum and/or minimum price, the number of desired or available items, delivery times and terms, service or working hours, etc. In addition, the public section 7 of the first data base 4 contains further statements 11 though 13 relating to the third party information 1, the purpose of which will be described hereafter.

The first data base 4 is provided with a queries interface 14 where potential second contracting parties Bᵢ may query the public section 7 especially about the description of the subject matter 3, the information statement 10 and the further statements 11 through 13.

The input interface 5, the first data base 4 and/or the queries interface 14 preferably classify the inputted third party information 1 according to predetermined classes of possible contractual subject matter, so that the second contracting parties Bᵢ may more easily search the first data base 4 for interesting third party information 1. In this connection, an expert system may be used which poses corresponding questions to, and leads, the agent V or the contracting party Bᵢ at the input interface 5 or at the queries interface 14.

The queries interface 14 may be set up such that it would carry out or accept a classification of a querying contracting party Bₗ, for instance as to the type of business or kind of use (e.g. personal or commercial), etc. Depending upon the classification of the second contracting party Bₗ, the queries interface 14 may block the queries, for instance, of business-unrelated third party information or of commercial third party information for non-commercial users and vice versa.

Access to the private section 6 of the first data base 4 will only be granted to a second contracting party Bᵢ if an auction module generally designated 15 permits such access, as schematically represented by a switch 16 controlled by the auction module 15.

The auction module 15 includes a second data base 17 into which second contracting parties Bₗ may input bids 19, by way of an input interface 18, for access to the private section 6 of the first data base 4 for certain third party information 1. FIG. 3 depicts a possible data record structure for storing a bid 19. The data record 19′ for bid 19 contains an unambiguous, unique bid identification “G” 20, a pass word “Bᵢ” 21 of the potential second contracting party Bᵢ making the bid, a reference 22 to the information identification “I”, optionally further data “InfB” 23 from the contracting party Bᵢ which are to be transmitted to the agent V or to the first contracting party A upon access to the private section 6, as well as a statement 24 about an offered closing fee P as a value parameter of the bid 19. The closing fee P is offered the agent V by the contracting party Bᵢ when a contract is actually closed between the second contracting party Bᵢ and the first contracting party A. The closing fee P may be a fixed fee or a percentage of the value of the contractual subject matter (commission percentage), as well as a barter transaction, goods, etc.

A bid fee “C” is associated with each bid 19. The bid fee C has initially to be paid to the operator of the computer system by the potential second contracting party Bᵢ making the bid 19. To this end, the computer system includes an accounts maintaining device 26 for keeping credit accounts 27 for at least each contracting party Bₗ making a bid. A collective storage 28 for collecting bid fees C is associated with the operator of the computer system. Each input of a bid 19 into the second data base 17 leads to a parallel transfer of the associated bid fee C from the credit account 27 of the inputting second contracting party Bᵢ to the collective storage 28.

It will be understood that the actual flow of currency from one of the second contracting parties Bₗ to the operator of the computer system may be arbitrarily set up in many different ways, for instance, by bank transfers, debiting of credit cards, telephone bills, “cybercash”, and so forth. The primary purpose of the accounts maintaining device 26 and the collective storage 28 is to record the flow of currency and to associate it with the contracting party Bᵢ and the operator of the computer system.

For practical purposes, the amount of the bid fee C will be set low, such as, for instance, 0.5 Euro (about 50¢) or less. Each bid 19 may be subject to a uniform bid fee C, or the bid fee C may vary depending upon the third party information 1, the agent V and/or the second contractual party Bᵢ. In the latter cases, the data record 19′ may additionally contain a statement 25 about the bid fee C associated with the bid, and/or the public section 7 of the first data base 4 may contain a statement 11 about the bid fee C which is to be paid for a bid relating to the third party information 1, and/or the queries interface 14 may dynamically calculate and indicate a bid fee C on the basis of the identity of the contracting party Bₗ.

In principle, the amount of the bid fee C may be set by the system, or it may be stated by a second contracting party Bₗ making a bid, that is to say it may be received in the context of a bid 19 by way of the input interface 18 of the second data base 17. In the former case, the bid fee C will in praxi be fixed, for instance, in relation to the value and probable desirability of the third party information 1, the probable number of second contracting parties Bᵢ making bids, and/or the estimated number of all potential contracting parties Bᵢ in the market place active in the given class or type of business, supplemented by data from statistics of previous auctions in this class or type of business. Based upon this, the bid fee C may be further fine-tuned on the basis of individual statistical data of each contracting party . In the second case, the amount of the bid fee C stated by a second contracting party Bᵢ makes it possible to perform a two step auction in the manner described.

Bids 19 may be fed into the second data base 17 only within a predetermined time window or up to a predetermined point t in time (“acceptance stop”). For that reason, there is schematically shown in the auction module 15 an auction device 29 which at the predetermined point t in time blocks the input of further bids into the data base 17 and the payment of further bid fees C into the collective storage 28 as schematically indicated by switches 30, 31, and which switches to evaluating the existing bids 19, as schematically indicated by the selector switch 32. The auction device 29 then determined those bids 19 which contain the N highest statements 24 of closing fees P, whereby N≧1. That is to say that there may be more than one “winner” at the auction.

The auction device 29 may be set up such that in determining the “winning” N bids 19 it considers or admits only those bids 19 in which the statement 25 of the bid fee C exceeds a predetermined threshold value and/or those bids 19 which belong to the bids with the M highest statements 25 of bid fees C, whereby M>N.

The auction device 29 or the auction module 15 will now grant access to the private section 6 of the first data base 4 to the “winning” contracting parties Bᵢ, and thus make it possible for a winning contracting party Bᵢ to access the contracting party identity 2 of the third party information 1.

At the same time, the auction device 29 initiates the transfer of all bid fees C collected in the collective storage 28 in favor of the agent V who had inputted this third party information 1, as schematically shown by the switch 33. For this purpose, the computer system is equipped with a further accounts maintaining device 34 for keeping credit accounts 35 at least for each agent V furnishing a third party information, and the transfer takes place from the collective storage 28 to the corresponding credit account 35. It will be understood that the accounts maintaining devices 26 and 34 may be one common accounts maintaining device.

It will also be clear that the actual flow of currency from the computer system operator's area of influence to the agent's area of influence may take place in any desired manner, for instance, in every manner described supra, and that above all, the accounts maintaining device 34 functions to record the currency flows.

The transfer of the collected bid fees C from the collective storage 28 to the credit account 35 of the agent V may be subject to a further condition represented by an optional switch 36 the purpose of which will subsequently be explained.

In fact, it is not the entire sum ΣC of all the bid fees C collected in the collective storage which is transferred to the credit account 35 of the agent V but only a predetermined share qΣC. For this purpose, a share calculator 37 is integrated into the transfer path from the collective storage 28 to the accounts maintaining device 34.

The predetermined share q preferably is a major portion of the sum of the bid fees ΣC; preferably q is in the range of 0.7 to 0.99, in particular about 0.8. The remaining amount (1−q)ΣC remains with the operator of the computer system and is transmitted to a corresponding collective account (not shown).

The acceptance stop t for a bid 19 as well as the number N of the “winners” of the auction for a certain third party information 1 may be rendered accessible to the contracting parties Bᵢ in the public section 7 of the first data base 4 (see fields 12 and 13 of the data set 19′). Alternatively, these data may be generated at the queries interface 14 and added to the queried third party information 1.

The computer system of FIG. 1 is also provided with an evaluation device 38 including a first interface 39 for receiving evaluation data R from an agent V and a second interface 40 for receiving evaluation data R from second contracting parties Bᵢ. In particular, each evaluation data R may assume the following values:

(no evaluation data);

“Contract closed”: A contract has been closed between the first contracting party A and one of the second contracting parties Bₗ to whom the entire third party information 1 had been disclosed;

“Evaluation” and “originating with one of the contracting parties Bₗ to whom the entire third party information had been disclosed”: This is an evaluation of the quality of the disclosed third party information 1.

The evaluation device 38 evaluates every incoming evaluation data R and executes the following evaluation logic within a predetermined interval of time T after the predetermined point in time t:

Even if the value of only one evaluation data R is “contract closed” the third party information 1 was authentic and the evaluation device 38 will cause the transfer of the closing fee P stated in the bid 19 of the contracting party Bᵢ which led to closing of the contract, to the credit account 35 of agent V as schematically shown by the switch 41. It is not the entire closing fee P which is being transferred, but an intermediate share calculator 42 transfers a share uP to the credit account 35. The remaining share (1−u)P is transmitted to a collective account (not shown) of the operator of the computer system. Simultaneously with the release of the transfer of the closing fee P the evaluation device 38 also releases the transfer of the bid fee sum ΣC described above. In case none of the received evaluation data R indicates “contract closed” and no evaluation data R was received from one of the contracting parties Bᵢ to whom the entire third party information 1 had been disclosed was received, it is obvious that while no contract was closed the third party information was nevertheless obviously authentic. While in that case the evaluation device 38 does not release the transfer of a closing fee P, it nevertheless enables the transfer of the bid fee sum ΣC.

in case none of the received evaluation data R indicates “contract closed” and a majority of the N contracting parties Bᵢ to whom the entire third party information 1 had been disclosed had transmitted an evaluation data R (or at least such a number of the N contracting parties Bₗ which exceeds a predetermined threshold value ), it will be assumed that the third party information was not authentic. In that case the evaluation device 38 will block the transfer of a closing fee P and also block the transfer of the bid fee sum ΣC. In addition, the evaluation device 38 may release the return of the bid fee sum ΣC stored in the collective storage 28 to the credit accounts 27 of the contracting parties Bᵢ which had input a bid 19.

It will be understood that instead of the disclosed blocking of the transfers by means of the switches 36 and 41 there may be provided corresponding return transfers. Thus, the entire share qΣC of the bid fee ΣC may be immediately credited to the credit account 35 of the agent V, and only after expiration of time interval T can the evaluation device 38 execute a corresponding return transfer from the credit account 35 to the credit accounts 27 of the contracting parties Bₗ. It is clear, that for this situation the switches 36, 40 are symbols of such an equivalent approach.

Furthermore, a data base 43 is connected to the evaluation device 38. The data base 43 maintains and updates statistical data 44′ for each agent V regarding all third party information 1 inputted by it and/or the evaluation data R received regarding its third party information 1, as well as statistical data 44″ for each contracting party Bᵢ which has made a bid 19 in respect of all of its bids 19 and/or its evaluation data R.

Based on the statistical data 44′ of an agent V the statistical data base 43 controls the share factor q which the agent V will receive of all its bid fees ΣC and/or that share factor u of a closing fee P which the agent V will receive. In the same manner, the statistical data base 43 may determine, on the basis of the statistical data 44″ of a certain contracting party Bₗ, the amount of the bid fee C which is to be paid by this contracting party for a bid 19 for certain third party information 1.

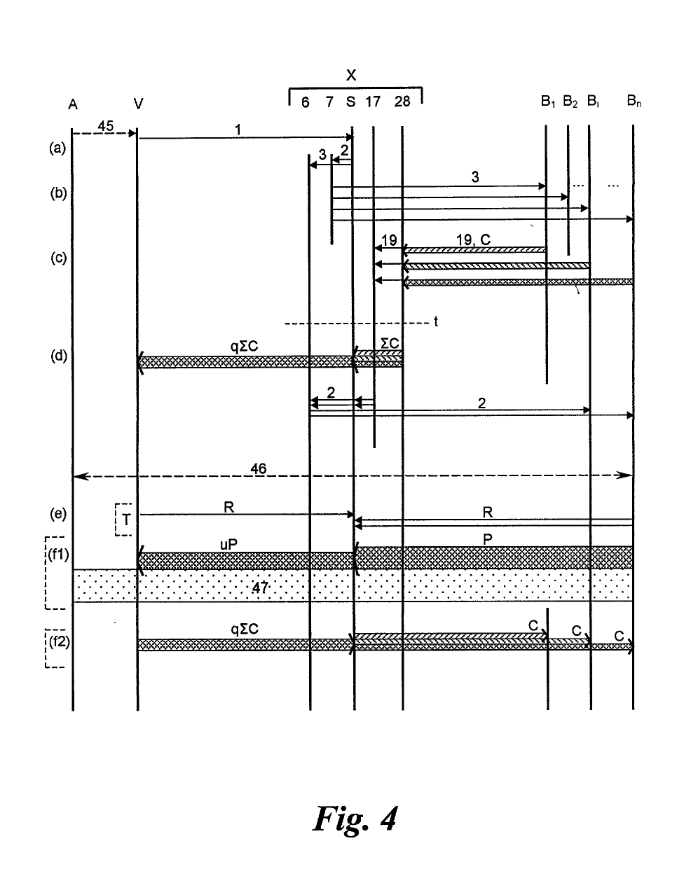

The sequence of the method in accordance with the invention will now be explained with reference to FIG. 4.

In a first step 45 external of the method proper, the first contracting party A informs the agent V about a desire to close a contract. In a step (a) the agent V transmits this data as third party information 1, including at least the identity 2 of the contracting party and the description of the contractual subject matter 3, to a location S, for instance the location of the computer system of FIG. 1 of a computer system operator X. The third party information 1 is or will be separated into its parts 2 and 3 at the time it is being stored.

In a second step (b) the second contracting parties B₁, B₂ . . . Bi . . . Bₙ will be granted access to the description of the contractual subject matter 3 from the third party information 1, and they will query it.

In step (c) bids 19 will be received from some of the contracting parties B₁, Bₗ and Bₙ for accessing the contracting party identity 2 of the third party information 1, each bid 19 including, in accordance with FIG. 3, at least a statement of a closing fee P which is being offered for the closing of a contract with the contracting party A and being accompanied by a bid fee C. The bids 19 are stored in the data base 17, the bid fees C are stored in the collective storage 28. The amount of the bid fee C may be set by the sender as well as by the recipient.

It will be understood that the collective storage 28 may be structured as a component of the data base 17. In the simplest case the mere listing of the bids 19 in the second data base 17 constitutes the collective storage 28 since the sum of the bid fees ΣC may be determined therefrom at any time.

At a predetermined point t in time the bids with the N highest statements of closing fees P are determined in step (d). In the example of FIG. 4, N=2. In this connection, only those bids can be considered the bid fee of which exceeds a certain threshold value and/or which belong to the M bids with the highest M bid fees, where M>N.

The contracting party identity 2 will now be transmitted and disclosed to the contracting parties Bᵢ and Bₙ which had made these N bids. At either the same time, or before or afterwards, a share qΣC of the sum ΣC of the bids will be transmitted to the agent V. Alternatively, this could take place at a significantly later point in time, for instance, upon expiry of the time interval T of the following step (e), or accumulated at fixed points in time etc.

Contract negotiations are taking place between the contracting party A and the contracting parties Bᵢ and Bₙ in a step 46 external of the method proper. In the example shown, the contracting party Bₙ prevails, and the contract is closed with contracting party Bₙ.

In step (e) evaluation data R are received from the agent V as well as from the second contracting parties B₁, B₂, Bᵢ, Bₙ and optionally even from the first contracting party A, within a predetermined time interval T following point in time t, for instance within a week, a month or, preferably, a year. Optionally evaluation data R will be accepted only from the agent V and from those contracting parties Bₗ and Bₙ to which the contracting party identity 2 had been transmitted.

Depending upon an assessment of the evaluation data R as described above with reference to Fig.1, steps (f1) or (f2) will now be executed. In step (f1) the closing fee P is received which was stated in the bid of that contracting party Bₙ with which the contract was closed and the share uP thereof is sent to the agent V. 47 represents the exchange of consideration between the first contracting party A and the second contracting party Bₙ in respect of the contractual subject matter which is external of the method.

In the alternative step (f2) the transfer of all received bid fees C is reversed, beginning with agent V, to location S or operator X and thence to the individual contracting parties B₁, B₂ and Bₙ.

The computer system shown in FIG. 1 and the method depicted in FIG. 4 may be realized or implemented by technical measures based upon hardware as well as software. The design of the corresponding software code segments for implementing the computer system components shown in FIG. 1 or of the method steps shown in FIG. 4 is known in the art.

The invention is, of course, not limited to the disclosed embodiments but embraces all variants and modifications falling into the ambit of the appended claims.

what is claimed is:

1. A method of controlling communications between at least one first contracting party and potential second contracting parties on the basis of third party information from an agent, the third party information including at least the identity of the first contracting party and a description of contractual subject matter, comprising the steps of:
(a) receiving and storing third party information;
(b) providing access to the contractual subject matter of the third party information for queries by second contracting parties;
c) receiving bids from second contracting parties for access to the identity of the first contracting party, each bid including at least a statement of a closing fee offered by the second contracting party for closing a contract with the first contracting party; receiving a bid fee for each bid from each second contracting party making a bid; and storing the bids and bid fees, and
d) determining the bids with the N highest statements of closing fees at a predetermined time with N≧1; transmitting the identity of the first contracting party to the N second contracting parties making the N bids; and transmitting at least a portion of all bid fees to the agent.

2. The method of claim 1, including the further steps of:
e) receiving evaluation data relative to the third party information within a predetermined interval of time, and
f1) if an evaluation data indicates that a contract has been closed between the first contracting party and one of the second contracting parties, receiving the closing fee included in the bid of the particular second contracting party and transmitting at least a share thereof to the agent, or
f2) if no evaluation data indicates closing of a contract, but evaluation data is received from a majority of the second contracting parties which have made the N bids, recovering the bid fees from the agent and returning them to the second contracting parties.

3. The method of claim 1, wherein only bids comprising the M highest statements of bid fees are admitted for determining the N bids, wherein M≧N.

4. The method of claim 1, wherein only bids the bid fee of which exceeds a predetermined threshold value are considered for determining the N bids.

5. The method of claim 1, wherein in respect of each agent statistical data is kept and updated about one of its third party information and evaluation data relating to all its third party information.

6. The method of claim 5, wherein at least one of the share of the bid fees and the share of the closing fee is determined on the basis of the statistical data.

7. The method of claim 1, wherein for every second contracting party submitting a bid there is maintained and updated statistical data regarding at least one of its bids and evaluation data.

8. The method of claim 7, wherein the bid fee is set on the basis of the statistical data and is accepted upon placement of a bid by the second contracting party.

9. The method of claim 1, wherein the second contracting parties are classified and the bid fee of a party is determined by the classification of that party.

10. The method of claim 1, wherein a statement of the amount of its bid fee is received in step c) from the second contracting party.

11. The method of claim 1, wherein N and the description of the contractual subject matter are made available for querying.

12. The method of claim 1, wherein the third party information includes a statement relating to the quality of the information which is made available for querying together with the description of the contractual subject matter.

13. The method of claim 12, wherein the statement relating to the quality of the information includes a statement of its origin.

14. The method of claim 1, wherein during storage the description of the contractual subject of the third party information matter is classified in accordance with predetermined classes.

15. The method of claim 14, wherein the third party information is classified by means of an expert system for guiding the agent.

16. The method of claim 14, wherein the bid fee is determined on the basis of the classification of the description of the contractual subject matter.

17. The method of claim 1, wherein the second contracting parties are classified and access to the description of the contractual subject matter by a predetermined second contracting party is only granted in dependence of the classification of the predetermined second contracting party.

18. The method of claim 17, wherein the reception of bids from a predetermined second contracting party is only granted in dependence of the classification of the predetermined second contracting party.

19. A computer system for controlling communications between at least one first contracting party and potential second contracting parties on the basis of third party information from an agent, the third party information including at least the identity of the at least one first contracting party and a description of the contractual subject matter, comprising:
a first data base provided with an input interface for the agent by which third party information is received, the first data base being provided with a private section and a public section, at least the identity of the first contracting party being stored in the private section and the description of the contractual subject matter being stored in the public section, and further with a queries interface by which potential second contracting parties may query the public section;
an accounts maintenance device for keeping credit accounts for each agent inputting third party information;
a second data base including an input interface by which second contracting parties may input bids for being granted access to the private section of the first data base regarding specific third party information, each bid including at least a statement of a closing fee offered by that second contracting party to close a contract with the first contracting party, and each bid having associated therewith a predetermined bid fee;
an accounts maintenance device for keeping credit accounts for every second contracting party submitting a bid;
a collective storage for collecting bid fees, each submission of a bid into the second data base causing the transfer of the associated bid fee from the credit account of the submitting second contracting party to the collective storage; and
an auction device for determining from the second data base at a predetermined point in time the bids having the N highest statements of closing fees, wherein N≧1, for granting to every second contracting party which has submitted one of the N bids access to the private section of the first data base in respect of the third party information relevant to the bid, and for causing the transfer of a predetermined share of all bid fees collected in the collective storage to the credit account of the agent having furnished the relevant third party information.

20. The computer system of claim 19, further comprising an evaluation device provided with at least one input interface for receiving evaluation data, the evaluation device enabling the reception of evaluation data relating to the third party information within a predetermined time interval and for causing the transfer of at least a share of the closing fee stated in the bid of a second contracting party from its credit account to the credit account of the agent if the evaluation data indicates the closing of a contract between the first contracting party and the second contracting party.

21. The computer system of claim 20, wherein the evaluation device causes the bid fees to be returned from the credit account of the agent to the credit accounts of the second contracting parties when evaluation data is received from a majority of the second contracting parties having placed the N bids and no closed contract is indicated by the evaluation device.

22. The computer system of claim 19, wherein the auction device determines the N bids on the basis of the bids comprising the M highest Statements of bid fees.

23. The computer system of claim 19, wherein the auction device determines the N bids on the basis of the bids the bid fee of which exceeds a predetermined threshold value.

24. The computer system of claim 20, further comprising a third data base connected to the evaluation device and storing and updating at least one of statistical data relating to the third party information from each agent and evaluation data pertaining to all the third party information from each agent.

25. The computer system of claim 24, wherein the data base for statistical data controls at least one of the size of the share of bid fees and the size of the share of the closing fee.

26. The computer system of claim 20, further comprising a fourth data base connected to the evaluation device and storing and updating statistical data relating to at least one of the bids of each bidding second contracting party or its evaluation data.

27. The computer system of claim 26, wherein the second data base determines the amount of the bid fee for a second contracting party.

28. The computer system of claim 19, wherein the second contracting parties are classified and the amount of a bid fee is determined in dependence of a classification of the second contracting party querying the first data base.

29. The computer system of claim 19, wherein the input interface of the second data base receives a statement from the second contracting party about the amount of the bid fee.

30. The computer system of claim 19, wherein the queries interface of the first data base makes available for querying the number N together with a description of the contractual subject matter.

31. The computer system of claim 19, wherein the third party information includes a statement about the quality of the information.

32. The computer system of claim 31, wherein the statement includes a statement about the origin of the quality statement.

33. The computer system of claim 19, wherein the input interface of the first data base classifies the description of the contractual subject matter from the third party information on the basis of predetermined classes.

34. The computer system of claim 33, wherein the classification by the input interface is aided by an expert system for guiding the agent.

35. The computer system of claim 33, wherein the amount of the bid fee is determined in dependence of the classification of the description of the contractual subject matter.

36. The computer system of claim 19, wherein the second contracting parties are provided with at least one of an identity and a classification and wherein the input interface of the second data base accepts bids from a second contracting party only in dependence of at least one of the identity and classification.

37. The computer system of claim 36, wherein the input interface of the first data base permits querying the public section only depending upon the classification of the querying second contracting party.

38. A computer program product embodied on a machine readable data carrier for controlling communications between at least one first contracting party and potential second contracting parties on the basis of third party information from an agent, the third party information including at least the identity of the first contracting party and a description of contractual subject matter, comprising:
a first code segment for receiving and storing third party information;
a second code segment for providing access to the contractual subject matter of the third party information for queries by second contracting parties;
a third code segment for receiving bids from second contracting parties for access to the identity of the first contracting party, each bid including at least a statement of a closing fee offered by the second contracting party for closing a contract with the first contracting party; for receiving a bid fee for each bid from each second contracting party making a bid; and for storing the bids and bid fees; and
a fourth code segment for determining the bids with the N highest statements of closing fees at a predetermined time with N≧1; for transmitting the identity of the first contracting party to the N second contracting parties making the N bids; and for transmitting at least a portion of all bid fees to the agent.
